(19) United States
(12) Patent Application Publication
(10) Pub. No.: US 2026/0265604 A1
(43) Pub. Date: Sep. 10, 2026

(54) PROPPANT PARTICULATES FORMED FROM DELAYED COKE AND METHODS RELATED THERETO

(71) Applicant: ExxonMobil Technology and Engineering Company, Spring, TX (US)

(72) Inventors: Peter A. GORDON, Yardley, PA (US); Lang FENG, New York, NY (US)

(21) Appl. No.: 19/657,588

(22) Filed: Apr. 24, 2026

Related U.S. Application Data
(63) Continuation-in-part of application No. 18/690,637, filed on Oct. 12, 2023, now Pat. No. 12,637,611.
Application No. 18/690,637 is a continuation-in-part of application No. 18/558,780, filed on Feb. 24, 2022.
(60) Provisional application No. 63/186,987, filed on May 11, 2021.
(60) Provisional application No. 63/382,968, filed on Nov. 9, 2022.

(51) Int. Cl. C09K 8/80

(52) U.S. Cl. CPC C09K 8/80

(57) ABSTRACT

Proppant particulates like sand are commonly used in hydraulic fracturing operations to maintain one or more fractures in an opened state following the release of hydraulic pressure. Fracturing fluids and methods of hydraulic fracturing may also use proppant particulates composed of petroleum coke material. Such proppant particulates may have improved transport into fractures because of lower density than traditional proppants like sand and may produce fewer fines that reduce fluid flow through proppant packs. The proppant particulates of the present disclosure are composed of thermally post-treated delayed coke and exhibit mechanical properties comparable to fluid coke and flexicoke petroleum coke materials for use as proppant particulates.

### CROSS-REFERENCE TO RELATED APPLICATIONS

This application is a continuation-in-part application of U.S. patent application Ser. No. 18/690,637, entitled “Proppant Particulates Formed From Delayed Coke And Methods Related Thereto” and filed Oct. 12, 2023, which is (i) a National Stage Entry Application of International Patent Application No. PCT/US2023/035050, entitled “Proppant Particulates Formed From Delayed Coke And Methods Related Thereto” and filed Oct. 12, 2023, which, in turn, claims priority to U.S. Provisional Patent Application Ser. No. 63/382,968 entitled “Proppant Particulates Formed From Delayed Coke And Methods Related Thereto” and filed on Nov. 9, 2022 and (ii) a continuation-in-part of U.S. patent application Ser. No. 18/558,780, entitled “Proppant Particulates Formed From Delayed Coke” and filed Nov. 3, 2023, which is a National Stage Entry of International Patent Application No. PCT/US2022/070811, entitled “Proppant Particulates Formed From Delayed Coke and Methods For Using the Same” and filed Feb. 24, 2022, which in turn claims priority to U.S. Provisional Patent Application Ser. No. 63/186,987, entitled “Proppant Particulates Formed From Delayed Coke and Methods For Using the Same” and filed May 11, 2021, the contents of each of which are incorporated herein by reference in their entirety.

### TECHNICAL FIELD

The present disclosure relates to fracturing operations and proppant particulates employed therein.

### BACKGROUND

A wellbore may be drilled into a subterranean formation in order to promote removal (production) of a hydrocarbon or water resource therefrom. In many cases, the subterranean formation needs to be stimulated in some manner in order to promote removal of the resource. Stimulation operations may include any operation performed upon the matrix of a subterranean formation in order to improve fluid conductivity therethrough, including hydraulic fracturing, which is a common stimulation operation for unconventional reservoirs.

Hydraulic fracturing operations pump large quantities of fluid into a subterranean formation (e.g., a low-permeability formation) under high hydraulic pressure to promote the formation of one or more fractures within the matrix of the subterranean formation and create high-conductivity flow paths. Primary fractures extending from the wellbore and, in some instances, secondary fractures extending from the primary fractures, possibly dendritically, may be formed during a fracturing operation. These fractures may be vertical, horizontal, or a combination of directions forming a tortuous path.

Proppant particulates are often included in a fracturing fluid in order to keep the fractures open after the hydraulic pressure has been released following a hydraulic fracturing operation. Upon reaching the fractures, the proppant particulates settle therein to form a proppant pack to prevent the fractures from closing once the hydraulic pressure has been released.

There are oftentimes difficulties encountered during hydraulic fracturing operations, particularly associated with deposition of proppant particulates in fractures that have been created or extended under hydraulic pressure. Because proppant particulates are often denser materials (compared to the hydraulic fracturing fluid used), effective transport of the proppant particulates may be difficult due to settling, making it challenging to distribute the proppant particulates into more remote reaches of a network of fractures.

Lower density particles like coke have been used in fracturing operations, for example, as described in U.S. Pat. No. 3,664,420, incorporated herein by reference in its entirety. In said patent, the coke is used as a far-field diverter and not a proppant. Far-field diverters pack into the tip or end of the primary and secondary fractures to form a very low-permeability zone. In the patent, after the far-field diverters are pumped into the fracture tips, proppant particles of higher density and larger size (e.g., metallic shot) are packed into the majority of the fractures to form high-permeability zones.

Fluid coke and flexicoke have previously been demonstrated as possessing mechanical properties that make them suitable for use as proppant during fracturing operations, including unconventional reservoirs. By contrast, delayed coke possesses weaker mechanical properties, and thus is viewed to be less efficacious in such fracturing operations, despite its widespread availability. The use of delayed coke as proppant is thus associated with a higher loss of measured fracture conductivity with increasing closure stress. There is a need for enhancing the mechanical properties of delayed coke for use as proppant particulates in subterranean fracturing operations.

### SUMMARY

The present disclosure generally relates to fracturing and, more specifically, to proppant particulates for fracturing that are formed from delayed coke, and methods related thereto.

In one aspect, the present disclosure provides proppant particulates including first proppant particulates comprising delayed coke that has been thermally post-treated to a temperature in a range of about 400° C. to about 1000° C.

In another aspect, the present disclosure provides proppant particulates including first proppant particulates having a D50 in a range from about 88 microns to about 250 microns and comprising delayed coke that has been thermally post-treated.

In yet another aspect, the present disclosure provides proppant particulates including first proppant particulates comprising delayed coke and having a bulk density of less than about 0.8 g/cm³.

In a further aspect, the present disclosure provides a method for producing proppant particulates, the method including: (a) providing a precursor material comprising delayed coke; (b) heating the precursor material at a temperature in a range from about 400° C. to about 1200° C. for a predetermined duration to obtain heat treated precursor material; and (c) obtaining the proppant particles from the heat treated precursor material.

These and other features and attributes of the disclosed methods and compositions of the present disclosure and their advantageous applications and/or uses will be apparent from the detailed description which follows.

### BRIEF DESCRIPTION OF DRAWINGS

The following drawings are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIGS. 1A-1C shows images comparing the size and shape of typical delayed coke compared to fluid coke.

FIG. 2 shows a chart of the results of fracture conductivity testing of typical delayed coke compared to fluid coke, flexicoke, and sand proppant particulates.

FIG. 3 is a simplified flowchart of the method and system of the present disclosure for treating delayed coke.

FIG. 4 shows comparative fracture conductivity results for fluid coke and traditional sand.

FIG. 5 shows comparative size distribution results for fluid coke and traditional sand.

FIG. 6 shows comparative shape distribution results for fluid coke and traditional sand.

FIGS. 7A and 7B show the effect of C/H ratio and TGA on delayed coke with thermal post-treatment, according to one or more aspects of the present disclosure.

FIG. 8 shows the apparent densities of delayed coke with thermal post-treatment, according to one or more aspects of the present disclosure.

FIG. 9A shows nanoindentation methodology and FIG. 9B illustrates a residual indentation formed on a delayed coke sample according to one or more aspects of the present disclosure.

FIGS. 10A and 10B show charts of nanoindentation results of delayed coke samples, fluid coke samples, epoxy reference sample, and traditional sand sample, according to one or more aspects of the present disclosure.

FIG. 11 shows a chart of stress-strain curves for various delayed coke 40/70 mesh samples, according to one or more aspects of the present disclosure.

FIGS. 12A and 12B show charts of fracture conductivity results of delayed coke samples, fluid coke samples and flexicoke samples according to one or more aspects of the present disclosure.

### DETAILED DESCRIPTION OF THE INVENTION

The present disclosure generally relates to fracturing and, more specifically, to proppant particulates for fracturing that are formed from delayed coke, and methods related thereto.

As discussed above, proppant particulates can be used effectively during fracturing operations, but there may be issues associated with their use. First, the high densities of typical proppant particulates may hinder their transport, possibly leading to inadequate proppant particulate disposition within one or a plurality of fractures. Second, some proppant particulates are prone to fines formation due to low crush strength values, which may lead to decreased fracture conductivity due to fines accumulation within the fracture.

The present disclosure alleviates the foregoing difficulties and provides related advantages as well. In particular, the present disclosure provides proppant particulates composed of delayed coke using a thermal processing route to enhance the mechanical properties of the delayed coke to be comparable to fluid cokes and flexicokes. The delayed coke proppant particulates are ground to mesh ranges of interest and exhibit low densities and high crush strengths, thereby addressing two significant shortcomings of traditional proppant particulates, generally formed from sand particles.

Typically, delayed coke is used as an inexpensive, low BTU fuel source in various manufacturing processes for heat. By using delayed coke as proppant particulates, one creates a useful application of the material with no associated CO₂ emissions. In effect, using delayed coke as proppant instead of as a fuel is a form of sequestering carbon that would otherwise contribute to CO₂ emissions.

Moreover, the costs associated with hydraulic fracturing may also be reduced at least because large volumes of delayed coke are readily available from already existent petroleum refinery process streams (~80% of all coke in total is delayed coke) and are typically cost-competitive compared to sand or other traditional proppant particulates; and their low density may decrease or eliminate the need to use gelled fracturing fluids (and the costs associated with gelation), thereby potentially reducing required pumping pressures, water consumption, and wellbore cleanout operations.

Additional advantages of the present disclosure that are not provided in current proppant particulate methodologies include, but are not limited to, moderate heat treatment short of full calcining, as commonly practiced, where heat treatments can reach 1200-1300° C., which has a profound impact on the mechanical strength of the material; careful removal of fines after grinding the delayed coke, which results in a proppant particulate product with vastly improved; and acceptable proppant particulate performance. Thermally post-treating green delayed coke at a temperature in a range from about 400° C. to about 1000° C., preferably from 400° C. to 800° C., preferably from 600 to 800° C., can result in coke material with significantly improved crush strength without overly increasing the apparent density, making the resultant particularly advantageous as proppant materials used in hydraulic fracturing operations.

Illustrative aspects of the present disclosure include fracturing fluids comprising proppant particulates composed of delayed coke, derived from a thermal processing route to enhance their mechanical properties. The delayed coke proppant particulates are suitable for propping one or more fractures induced during a hydraulic fracturing operation within a horizontal, vertical, or tortuous wellbore, including hydrocarbon-bearing production wellbores and water-bearing production wellbores, and in unconventional formations (e.g., sandstone, shale, and the like).

### Definitions and Test Methods

As used herein, the term “proppant particulate” or simply “proppant,” and grammatical variants thereof, refers to a solid material capable of maintaining open an induced fracture during and following a hydraulic fracturing treatment. The term “proppant pack” refers to a collection of proppant.

As used herein, the term “delayed coke,” “green delayed coke,” “as-made delayed coke,” and “freshly made delayed coke,” and grammatical variants thereof, refer to a carbonaceous material produced from a delayed coker operated in a delayed coking process, optionally having been ground and/or sieved. In the delayed coking process, heavy hydrocarbon feeds are subjected to an elevated temperature (e.g., 400 to 500° C.) in a coke drum, where the heavy hydrocarbons crack to produce lighter hydrocarbons, and leaving a residual carbonaceous solid material known as delayed coke. Delayed coke in this disclosure can include, but are not limited to, shot coke, sponge coke, and needle coke. A majority of delayed coke produced in the present day petroleum refineries are shot coke, which is preferred in this disclosure for making the thermally post-treated delayed coke useful for making proppant particulates. Shot coke is typically considered as a relatively low value product because of its low calorific value and relatively high concentrations of impurities such as sulfur. In addition, green, as-made shot coke produced directly from a delayed coker tends to have a relatively low crush strength, making them less than desirable for use directly as high-performance proppant materials in hydraulic fracturing operations. Surprisingly, by thermally post-processing shot coke (and other types of delayed coke) as disclosed herein, a significantly improved coke material can be produced, which can have significantly increased crush strength, making it suitable as high-performance proppant materials in hydraulic fracturing operations.

Delayed coke may be characterized as having a sulfur content in the range of about 1 weight percent (wt. %) to about 8 wt. %, volatile matter in the range of about 8 wt. % to about 15 wt. %, a Hargrove grindability index in the range of about 30 to 130, and a density in the range of about 1.2 to about 1.4.

As used herein, the term “thermally post-treated delayed coke proppant particulates,” and grammatical variants thereof, refers to a delayed coke that has at least been heat treated after the coking process, as described herein. The term further encompasses such heat treated delayed coke that has been ground and, optionally, had fines removed. That is, unless otherwise indicated, the term “thermally post-treated delayed coke proppant particulates” encompasses heat treated and ground (the term “ground,” and grammatical variants thereof, encompasses “milled” in all instances, depending on the particular machinery utilized) delayed coke that may or may not have fines removed.

As used herein, the term “fluid coke,” and grammatical variants thereof, refers to a material obtained through a carbon rejection process that is used for upgrading heavy hydrocarbon feeds and/or feeds that are challenging to process. The process produces a variety of lighter, more valuable liquid hydrocarbon products, as well as a substantial amount of fluid coke as byproduct. The fluid coke byproduct comprises high carbon content and various impurities. A distinguishing characteristic of fluid coke is that the carbon rejection process occurs in a fluidized bed (continuous) process, where the material is mixed and circulating at all times during the reaction process, which is a contract to delayed coke which forms a bed of rejected carbon in a batch process.

The term “flexicoke,” and grammatical variants thereof, refers to a material produced from a modified variation of fluid coking, termed FLEXICOKING™ (trademark of ExxonMobil Research and Engineering Company (“ExxonMobil”)). FLEXICOKING™ is based on fluidized bed technology developed by ExxonMobil, and is a carbon rejection process that is used for upgrading heavy hydrocarbon feeds. Unlike fluid coking, which utilizes a reactor and a burner, the FLEXICOKING™ process uses a reactor, a heater, and a gasifier.

As used herein, the term “apparent density,” with reference to the density of proppant particles, refers to the density of the individual particles themselves, which may be expressed in grams per cubic centimeter (g/cm³ or g/cc). The apparent density values provided herein are based on the American Petroleum Institute's Recommended Practice 19C (hereinafter “API RP-19C”) standard, entitled “Measurement of Properties of Proppants Used in Hydraulic Fracturing and Gravel-packing Operations” (First Ed. May 2008, Reaffirmed June 2016).

As used herein, the term “bulk density,” and grammatical variants thereof, with reference to the density of proppant particulates, refers to the density of a proppant pack, which may be expressed in g/cm³. The bulk density values of the present disclosure are measured pursuant to API RP-19C (2020) entitled “Measurement of Proppants Used in Hydraulic Fracturing and Gravel-packing Operations.”

The term “carbon to hydrogen ratio” or “C/H ratio,” and grammatical variants thereof, refers to an amount of elemental carbon to elemental hydrogen within a petroleum composition. The C/H Ratio is measured according to ASTM D5373-21 entitled “Test Methods for Determination of Carbon, Hydrogen and Nitrogen in Analysis Samples of Coal and Carbon in Analysis Samples of Coal and Coke.”

As used herein, the term “thermal gravimetric analysis” or “TGA,” and grammatical variants thereof, refers to the weight loss versus the temperature (° C.) of a sample, and represents % degradables as measured pursuant to ASTM-D7582 (Test Methods for Proximate Analysis of Coal and Coke by Macrogravimetric Analysis).

As used herein, the term “fracture conductivity” refers to the degree to which fluid can flow in a proppant-filled fracture. It is a stress-dependent quantity, and is typically evaluated at various stress (pressure) levels. The fracture conductivity values of the present disclosure are based on the American Petroleum Institute's Recommended Practice 19D (API RP-19D) standard entitled “Measuring the Long-Term Conductivity of Proppants” (First Ed. May 2008, Reaffirmed May 2015).

As used herein, the term “crush strength,” with reference to proppant particulates, refers to the stress load proppant particulates can withstand prior to crushing (e.g., breaking or cracking). The crush strength values of the present disclosure are based on API RP-19C.

All numerical values within the detailed description and the claims herein are modified by “about” or “approximately” with respect to the indicated value, and take into account experimental error and variations that would be expected by a person having ordinary skill in the art.

The term “particle size(s),” when used herein with reference to a type of particles, refers to the diameter(s) of such particle(s). The term “particle size distribution,” when used herein with reference to a type or a collection of particles, refers to the range of diameters for such particles, typically from the minimal to the maximal. The terms “average particle size distribution” and “D50” when used herein with reference to a type or a collection of particles, interchangeably mean the median particle size of the particles.

As used in the present disclosure and claims, the singular forms “a,” “an,” and “the” include plural forms unless the context clearly dictates otherwise.

The term “and/or” as used in a phrase such as “A and/or B” herein is intended to include “A and B,” “A or B,” “A,” and “B.”

### Proppants, Methods, and Systems

Hydraulic fracturing operations require effective proppant particulates to maintain the permeability and conductivity of a production well, such as for effective hydrocarbon recovery. Effective proppant particulates are typically associated with a variety of particular characteristics or properties, including efficient proppant particulate transport within a carrier fluid, sufficient crush strength to maintain fractures propped upon the removal of hydraulic pressure, and efficient conductivity once the wellbore is brought on production.

The rate of settling of a proppant particulate within a fracturing fluid at least in part determines its transport capacity within one or more fractures created during a hydraulic fracturing operation. The rate of settling of a proppant particulate may be determined using Equation 1:

$$v = \frac{{ρ}_{p} - {ρ}_{f}}{18 η} g {σ}^{2} , \qquad Equation 1$$

where v is the settling rate of the proppant particle; ρₚ−ρ_{f} is proportional to the density difference between the proppant particle and the carrier fluid; η is the viscosity of the carrier fluid; g is the gravitational constant; and σ² is proportional to the square of the proppant particulate size. As will be appreciated, proppant particulates having lower apparent densities and/or smaller average particle sizes settle at a slower rate within an identical carrier fluid (thus having better transport) compared to higher apparent density and/or larger average particle size proppant particulates.

Proppant particulate efficacy is further related to fracture conductivity, characterized by the fluid flow rate in a propped fracture under gradient pressure, the fracture being propped by a proppant pack. Fracture conductivity, C_{f}, is the product of the proppant pack permeability, k, and its thickness, h, and may be determined using Equations 2 and 3:

$${C}_{f} = kh , \qquad Equation 2$$

$$k = \frac{1}{C} \frac{{ϕ}^{3}}{{( 1 - ϕ )}^{2}} {σ}_{e f f}^{2} {Φ}_{s}^{2} , \qquad Equation 3$$

where C is a constant; φ is the proppant pack void fraction; σ is the average particle size diameter of the proppant particulates; and Φ is a shape factor related to the asphericity of the proppant particulates. In tension with settling rate and transport, fracture conductivity favors proppant particulates having larger average particle size diameters, as well as thick proppant packs and narrow particle size distribution.

Fracture conductivity is related to the mechanical properties of proppant particulates. These properties can be characterized using nanoindentation analysis according to the Oliver-Pharr scheme to obtain local mechanical properties of proppant particulates. As used herein, the term “nanoindentation,” and grammatical variants thereof, refers to a method for measuring mechanical properties of a material. Nanoindentation measurements according to the present disclosure were performed using a nanoindenter equipped with a diamond Berkovich tip geometry that is driven onto proppant particulate surfaces over an 8×8 square grid of points separated by about 6 μm. Reduced elastic modulus (Eᵣ) and the local hardness (H) are two mechanical properties determined from nanoindentation measurements, mathematically defined in equations 4.1 and 5 below, respectively. Reduced elastic modulus can be taken to approximate the material modulus with the limitation that the nanoindenter modulus is large compared to the investigated material. The local hardness is defined as the ratio of the maximum load and the indentation contact area. A nanoindenter makes measured indents using a calibrated diamond tip onto the surface of a material to establish a load-displacement curve. The load (P)-displacement (h) curve is established by contacting the tip of the nanoindenter onto the surface of a material to a maximum force, followed by retraction of the tip. The stiffness(S) is experimentally determined as the slope of the load-displacement curve during initial unloading, and the reduced elastic modulus is determined via the relationship according to Equation 4:

$$S = \frac{d P}{d h} = \frac{2}{\sqrt{π}} {E}_{r} \sqrt{A ( h )} , \qquad Equation 4$$

Where A(h) is the projected area of the nanoindenter tip and for a given geometry is a known function of penetration depth. The reduced modulus Eᵣ is related to Young's modulus E_{S} of the test sample according to equation 4.1:

$$\frac{1}{{E}_{r}} = \frac{1 - {ν}_{i}^{2}}{{E}_{i}} + \frac{1 - {ν}_{s}^{2}}{{E}_{s}} \qquad Equation 4.1$$

Where Eₛ and vₛ are Young's modulus and Poisson's ratio of the proppant particulate sample, and Eᵢ and vᵢ are Young's modulus and Poisson's ratio of the indenter tip. For a diamond indenter, Eᵢ=1140 GPa and vᵢ=0.07 and the term

$$\frac{1 - {ν}_{i}^{2}}{{E}_{i}}$$

is negligible for the samples of interest here.

The local hardness (H) of the material is determined according to Equation 5:

$$H = \frac{{P}_{max}}{A} , \qquad Equation 5$$

where Pₘₐₓ is the maximum load and A is the contact area established by the nanoindenter tip under the maximum applied load.

As provided hereinabove, typical delayed coke has been shown to exhibit poor mechanical qualities compared to fluid coke and flexicoke, with consequent reduction in fracture conductivity. Comparing delayed coke to flexicoke, several stark differences are noted, among others as described herein.

First, the size and shape of green delayed coke as freshly made from a delayed coker in a delayed coking process, and ground delayed coke produced by grinding green delayed coke differ significantly from those of fluid coke as made from a fluid coker of a fluid coking process and flexicoke as made from a flexicoker of a flexicokng process. Fluid coke and flexicoke particulates are more rounded and spherical in nature, owing to the environment in which they are formed, and a significant fraction of the size distribution of particles lies between 100 and 500 micrometers (μm), already in the range of interest for proppant particulates used in fracturing operations. By contrast, green shot coke (a form of delayed coke), for example, forms as generally spherical agglomerates ranging from between 1 millimeter (mm) to 4.5 mm (e.g., about the diameter of a golf ball). Accordingly, a reduction in particle size is required to be useful as a proppant particulate (e.g., by grounding such as ball, jet, or hammer milling). Such grinding results in proppant particles having less rounded, angular shapes, and a significant amount of fine particles, e.g., particles have a size smaller than 50 μm, that can lower fracture conductivity if included at a high quantity with larger proppant particles.

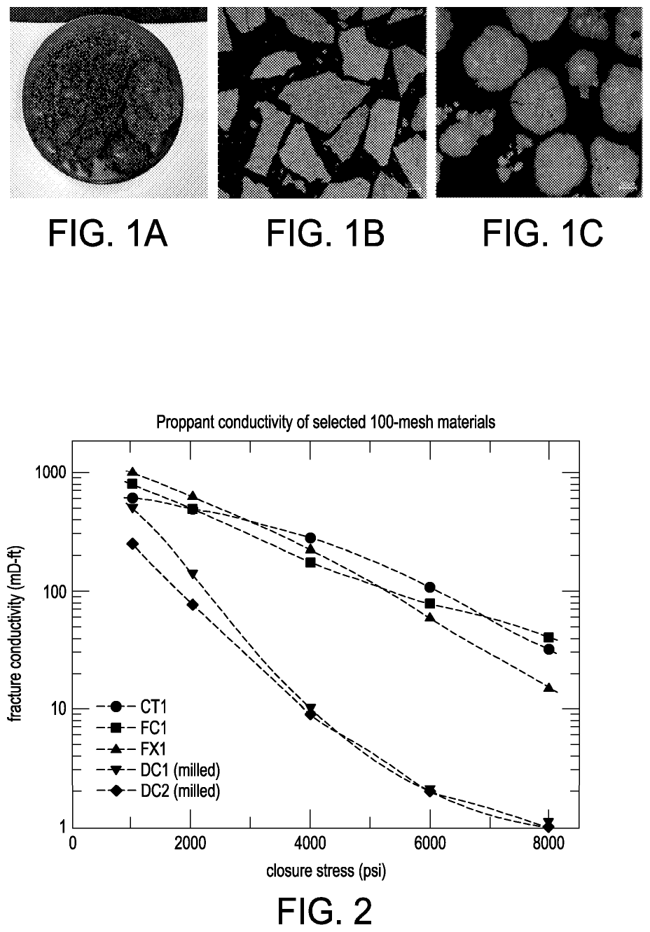

The size and shape differences described above are shown in FIGS. 1A-1C FIG. 1A shows an image of green shot coke freshly produced from a delayed coker in a delayed coking process. As noted above, the generally spherical agglomerates are quite large in size (1 mm to 4.5 mm). FIG. 1B shows polarized light micrograph of sample ground shot coke particles rigorously sieved to have a size of about 100 mesh. FIG. 1C shows a polarized micrograph of sample fluid coke particles as made from a fluid coker in a fluid coking process. The bulk density of the ground shot coke of FIG. 1B was measured at 0.62 grams per cubic centimeter (g/cm³) to 0.64 g/cm³, whereas the measured bulk density of the ground fluid coke of FIG. 1C was 0.76 g/cm³ to 0.86 g/cm³. This is a consequence of the more angular nature of the ground particles, which pack together less efficiently and result in a lower density than the more spherical particulates comprising fluid coke.

A second notable difference between delayed coke compared to both fluid coke and flexicoke is their volatile matter content. Volatile matter is composed of heavy hydrocarbons in the petroleum coke particle matrix and in the pores thereof, and represents an incomplete transformation of residual oil molecules into (relatively) hydrogen deficient, aromatic domains that structurally order into layered complexes. Delayed coke as freshly made from a delayed coker in a delayed coking process typically has higher level of volatile matter compared to both fluid coke freshly made from a fluid coker and flexicoke freshly made from a flexicoker. Indeed, green delayed coke freshly made from a delayed coker typically has a volatile matter content in the range of about 8 wt. % to about 15 wt. %, whereas freshly made fluid coke and flexicoke typically have a volatile matter content in the range of about 2 wt. % to about 6 wt. %, which may be due to the relative higher thermal severity of the coking process of fluid coke and flexicoke compared to the The higher volatile matter content implies a lower degree of delayed coking process. polymerization and graphitization, and may be at least partly responsible for the lower mechanical strength associated with green delayed coke.

Without being bound by theory, due to the aforementioned differences, and others not described herein, it is observed that typical green delayed coke has lesser mechanical strength, and thus lesser fracture conductivity for use as proppant particulates, compared to the fluid coke and flexicoke, as well as traditional proppant particulates (e.g., sand). Such results can be observed in FIG. 2, illustrating the fracture conductivities, as measured pursuant to API RP 19D, of 100-mesh shot coke compared to each of fluid coke, flexicoke, and traditional sand, as described in Example 1. Briefly, the fluid coke, flexicoke, and sand demonstrated similar fracture conductivities, whereas the shot coke exhibited significantly reduced fracture conductivities, particularly as closure stresses increase.

The present disclosure provides a method off or producing proppant particulates, the method comprising:
(a) providing a precursor material comprising delayed coke;
(b) heating the precursor material at a temperature in a range from about 400° C. to about 1200° C. for a predetermined duration to obtain heat treated precursor material; and
(c) obtaining the proppant particles from the heat treated precursor material.

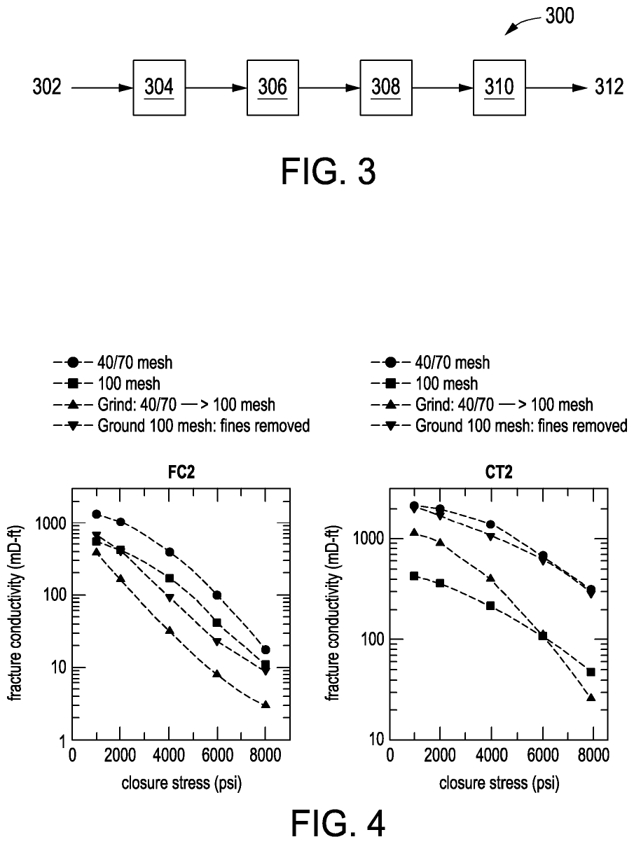

Referring now to FIG. 3, illustrated is a simplified flowchart of the system 300 of the present disclosure for treating delayed coke. Delayed coke 302 is received from a traditional delayed coker system. The received delayed coke 302 is generally in large agglomerate form. Thereafter, the delayed coke 302 is ground 304 using one or more grinding and/or milling devices to a size of interest. The grinding and/or milling devices are not considered to be particularly limiting and may include, but are not limited to, a grinding wheel, a ball mill, a jet mill, a hammer mill, or other suitable milling (grinding) devices. In one or more aspects, the delayed coke 302 may be ground 304 to a size having an average diameter in the range of about 100 μm to about 600 μm, encompassing any value and subset therebetween, such as about 100 μm to about 400 μm, or about 200 μm to about 400 μm, or about 100 μm to about 200 μm.

With continued reference to FIG. 3, after grinding 304, the ground delayed coke is heat treated 306 to a specified temperature and duration. The heat treatment may be performed in any heater or kiln suitable at achieving desired temperatures. In one or more aspects of the present disclosure, the heat treatment 306 is performed to achieve pyrolysis-like conditions, which may be performed in a kiln, such as a rotary calciner. The particular temperature and duration of the heat treatment 306 may depend on a number of factors including, but not limited to, the particular hydraulic fracturing operation and conditions related thereto for which the end-product, treated delayed coke proppant particulates are to be used. For example, in some aspects, the heat treatment 306 temperature may be in the range of about 400° C. to about 1000° C., encompassing any value and subset therebetween, such as about 400° C. to about 800° C., or about 600° C. to about 800° C., e.g., 400, 425, 450, 475, 500, 525, 550, 575, 600, 625, 650, 675, 700, 725, 750, 775, 800, 825, 850, 875, 900, 925, 950, 975, and 1000° C. A preferred temperature range is from 400° C. to 800° C., more preferably from 600° C. to 800° C., under which green delayed coke can be treated within a reasonably short period of time without having to use equipment resistant to very high temperatures such as over 800° C., and without causing the apparent density of the treated delayed coke to exceed 2.1 g·cm⁻³. In general, all other properties (e.g., crush strength) being equal, the lower the density of the coke, the better it is for use as proppant materials. The duration of the heat treatment 306 may be in the range of about 15 minutes to about 24 hours, encompassing any value and subset therebetween, such as about 1 hour to about 15 hours, or about 1 hour to about 5 hours, e.g., 0.25, 0.5, 0.75, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10, 11, 12, 13, 14, 15, 16, 17, 18, 19, 20, 21, 22, 23, 24 hours. The heat treatment may be in the presence of a gas, such as air, oxygen, steam, nitrogen, and the like, and any combination thereof.

After heat treatment 306, the ground and heat treated delayed coke may be processed to remove fines particles 308. Such fines removal process 308 may be performed by any suitable separation device and is not considered to be particularly limited. In one or more aspects, for example, the separation device may include, but is not limited to, an elutriator, a cyclone, hydrosizer, or other separation equipment. The fines removal process 308 is performed to minimize any particles that fall outside the desired range during grinding 304, such as a desired range between the average diameter sizes of about 100 μm to about 600 μm.

With continued reference to FIG. 3, after the fines removal process 308, the delayed coke material is sieved 310 using a sieving device to a particle size range of interest for proppant particulates used during hydraulic fracturing operations. The sieving device is not considered to be particularly limited and examples include, but are not limited to, a mechanical vibratory sieve, a manual sieve, and air elutriator, and the like. The size of the sieving may be any suitable size for performance in a particular fracturing operation, such as, but not limited to, 30/50 mesh (300 μm to 600 μm), 40/70 (212 μm to 420 μm), 70/140 mes (106 μm to 212 μm), and the like.

Final, treated delayed coke proppant particulates 312 are thereafter obtained and possess suitable mechanical properties for use in hydraulic fracturing operations. In certain embodiments, the final proppant participants made from thermally post-treated delayed coke can have a median particle size (D50) in a range from about 88 microns to about 250 microns, e.g., 88, 90, 95, 100, 105, 110, 115, 120, 130, 140, 150, 160, 170, 180, 185, 190, 200, 210, 220, 230, 240, 250 microns. Proppant particulates having D50 larger than 250 microns contain too much large particles having sizes larger than 250 microns, which cannot enter small fractures, resulting in poor propping performance during hydraulic fracturing. Proppant particulates having D50 lower than 88 microns contain too much fine particles having sizes smaller than 88 microns, which can clog pores in proppant packs in the fractures, resulting in reduced conductivity. In certain preferred embodiments, at least 50 vol % (e.g., 50, 55, 60, 65, 70, 75, 80, 85, 90, 95, 100, vol %), preferably at least 60 vol %, more preferably at least 80 vol %, of the thermally post-treated delayed coke-based proppant particulates have particle sizes in the range from about 88 microns to about 250 microns. We have found that thermally post-treated delayed coke particles having sizes ranging from about 88 microns to about 250 microns are particularly advantageous as proppant particulates in hydraulic fracturing operations, especially for the purpose of unconventional hydrocarbon production. In preferred embodiments, the thermally post-treated delayed coke proppant particulates comprises no more than 15 vol %, more preferably no more than 10 vol %, still more preferably no more than 5 vol %, still more preferably no more than 3 vol %, of particles having sizes smaller than 105 microns, based on the total volume of the thermally post-treated delayed coke proppant particulates. In preferred embodiments, the thermally post-treated delayed coke proppant particulates comprises no more than 15 vol %, more preferably no more than 10 vol %, still more preferably no more than 5 vol %, still more preferably no more than 3 vol %, of particles having sizes smaller than 88 microns, based on the total volume of the thermally post-treated delayed coke proppant particulates. In preferred embodiments, the thermally post-treated delayed coke proppant particulates comprise no more than 15 vol %, more preferably no more than 10 vol %, still more preferably no more than 5 vol %, still more preferably no more than 3 vol %, of particles having sizes smaller than 74 microns, based on the total volume of the thermally post-treated delayed coke proppant particulates. Particles larger than 250 microns have drawbacks of shorter distance of travel in the fracture fluid and propensity to clog pumping equipment. Hence, in preferred embodiments, the thermally post-treated delayed coke proppant particulates comprise no more than 15 vol %, more preferably no more than 10 vol %, still more preferably no more than 5 vol %, still more preferably no more than 3 vol %, of particles having sizes larger than 250 microns, based on the total volume of the thermally post-treated delayed coke proppant particulates.

In preferred embodiments, the thermally post-treated delayed coke-based proppant particulates have apparent density in the range from 1.2 g·cm⁻³ to 2.1 g·cm³ (e.g., 1.2, 1.3, 1.4, 1.5, 1.6, 1.7, 1.8, 1.9, 2.0, 2.1 g·cm⁻³), more preferably from 1.2 g·cm⁻³ to 1.8 g·cm⁻³, still more preferably from 1.4 g·cm⁻³ to 1.6 g·cm⁻³. Within this range from 1.2 g·cm⁻³ to 2.1 g·cm⁻³, a higher density can correlate to a higher crush strength. However, all other properties being equal, a lower density of the particulates is preferred because lower density particulates can be carried farther by the carrier fluid in a hydraulic fracturing operation, thereby propping fractures at longer distances.

It is to be noted that FIG. 3 is not an exclusive process for performing the heat treatment enhancement of delayed coke as provided herein. For example, each of steps 304-312 may be performed in any order, without departing from the scope of the present disclosure. Moreover, certain steps in FIG. 3 may be repeated more than once (e.g., multiple milling devices may be used, multiple separating devices may be used, and the like) or, alternatively, one or more of the steps may be combined into a single step (e.g., the heating device may also serve as one or both of a separation device and/or sieving device). That is, the process illustrated in FIG. 3 is nonlimiting.

The thermally post-treated delayed coke proppant particulates of the present disclosure are formed using traditional delayed coking processes, as described herein, and further heat treated to a temperature in the range of about 400° C. to about 1000° C., or about 600° C. to about 800° C., encompassing any value and subset therebetween. The duration of the heat treatment may range from about 15 minutes to about 24 hours, or about 1 hour to about 12 hours, or about 1 hour to about 6 hours, or about 1 hour to about 4 hours, encompassing any value and subset therebetween to achieve improved mechanical response. The temperature and time is selected to achieve improved mechanical response.

After grinding, but before or after heat treatment, fines may be removed from the delayed coke for preparation of the thermally post-treated delayed coke proppant particulates described herein. In one or more instances, the fines are removed such that not more than about 10% (including 0%) of the particulates have a diameter below a desired size range, as described herein.

The thermally post-treated delayed coke proppant particulates may have a reduced elastic modulus in the range of about 5 gigapascals (GPa) to about 50 GPa, such as about 10 GPa to about 40 GPa, encompassing any value and subset therebetween.

The thermally post-treated delayed coke proppant particulates may have a local hardness value in the range of about 1 GPa to about 5 GPa, such as about 2 GPa to about 4 GPa, encompassing any value and subset therebetween.

The thermally post-treated delayed coke proppant particulates described herein may have a carbon content of about 80 wt. % to about 99.5 wt. %, or about 85 wt. % to about 96 wt. %, encompassing any value and subset therebetween.

The thermally post-treated delayed coke proppant particulates described herein may have a weight ratio of carbon to hydrogen of about 50:1 to about 120:1, or about 60:1 to about 98:1, encompassing any value and subset therebetween.

The thermally post-treated delayed coke proppant particulates described herein may have a percent degradables, as measured by TGA, in the range of about 0% to about 3%, encompassing any value and subset therebetween.

The thermally post-treated delayed coke proppant particulates described herein may have an impurities content (weight percent of all components other than carbon and hydrogen) of about 1 wt. % to about 15 wt. %, or about 3 wt. % to about 10 wt. %, encompassing any value and subset therebetween.

The thermally post-treated delayed coke proppant particulates described herein may have a sulfur content of 0 wt. % to about 6 wt. %, or about 0.2 wt. % to about 5 wt. %, encompassing any value and subset therebetween.

The thermally post-treated delayed coke proppant particulates described herein may have a nitrogen content of 0 wt. % to about 2 wt. %, or about 0.1 wt. % to about 1 wt. %, encompassing any value and subset therebetween.

The apparent density of the thermally post-treated delayed coke proppant particulates of the present disclosure may be in the range of about 1.4 grams per cubic centimeter (g/cm³) to about 2.1 g/cm³, or about 1.4 g/cm³ to about 1.8 g/cm³, encompassing any value and subset therebetween. Traditional sand proppant particulates generally have apparent densities greater than about 2.5 g/cm³. Thus, the thermally post-treated delayed coke proppant particulates described herein have substantially lesser apparent densities compared to traditional sand proppant particulates, which is indicative of their comparably more effective transport and lower settling rates within a fracture formed as part of a hydraulic fracturing operation.

The bulk density of the thermally post-treated delayed coke proppant particulates may be less than about 0.7 g/cm³, such as in the range of about 0.5 g/cm³ to about 0.65 g/cm³, encompassing any value and subset therebetween.

Typical proppant particulates are comprised of sand having particle diameters ranging from about 100 micrometers (μm) to about 1000 μm. The thermally post-treated delayed coke proppant particulates described herein are comparable to traditional proppant particulates in particle diameter size, having an average diameter of about 100 μm to about 500 μm, or about 100 μm to about 400 μm, or about 150 μm to about 350 μm, encompassing any value and subset therebetween.

As shown below, the deformation of the thermally post-treated delayed coke proppant particulates of the present disclosure may be at least partially size dependent. In some aspects, the crush strength of the thermally post-treated delayed coke proppant particulates described herein may be in the range of about 3000 psi to about 12,000 psi, or about 3000 psi to about 6000 psi, or about 5000 psi to about 10,000 psi, or about 7500 psi to about 12,000 psi.

The fracture conductivity of a proppant pack comprising the thermally post-treated delayed coke proppant particulates of the present disclosure is comparable to traditional sand proppant particulates, as well as fluid coke and flexicoke proppant particulates, particularly at comparable particle sizes, as described herein.

The thermally post-treated delayed coke proppant particulates described herein may be used as part of a fracturing fluid, comprising a flowable (e.g., liquid or gelled) carrier fluid and one or more optional additives. This fluid is usually formulated at the well site in a mixing process that is conducted while it is being pumped in the hydraulic fracturing process. When the fluid is formulated at the well site, thermally post-treated delayed coke proppant particulates can be added in a manner similar to the known methods for adding sand into the fracturing fluid. In some aspects, it may be preferred that delayed coke proppant particulates received from a coking process are first processed (e.g., at the manufacturing facility) to provide the thermal post-treatment and/or to remove any undesirably sized material (fines) prior to their use as proppant particulates. Optionally the thermal post-treatment and/or fines removal may be conducted at another facility, or be done in the field. Fines may be removed, for example, such as by use of bag filters or other separation methods, whether in storage, during transport, or in the field, in order to obtain a more uniform size distribution. In addition to the thermally post-treated delayed coke proppant particulates, it is within the scope of the present disclosure that the thermally post-treated delayed coke proppant particulates be included alone or in combination with one or more other types of proppant particulates (e.g., fluid coke or flexicoke, and even traditional proppant particulates). When thermally post-treated delayed coke proppant particulates are included in combination with another type of proppant particulate, the various proppant particulates can be mixed as a dry solid, mixed in a slurry, or added separately into a fracturing fluid that is being formulated at a facility or at the well site.

The carrier fluid of the present disclosure may be an aqueous-based fluid or a nonaqueous-based fluid. Aqueous-based fluids may include, for example, fresh water, saltwater (including seawater), treated water (e.g., treated production water), other forms of aqueous fluid, and any combination thereof. One aqueous based fluid class is often referred to as slickwater, and the corresponding fracturing operations are called slickwater fracturing. Nonaqueous-based fluids may include, for example, oil-based fluids (e.g., hydrocarbon, olefin, mineral oil), alcohol-based fluids (e.g., methanol), liquefied or supercritical CO₂ (carbon dioxide), and any combination thereof. In one or more aspects, the carrier fluid selected for the present disclosure are aqueous-based fluids.

In various aspects, the viscosity of the carrier fluid may be altered by foaming or gelling. Foaming may be achieved using, for example, air or other gases (e.g., CO₂, N₂), alone or in combination. Gelling may be achieved using, for example, guar gum (e.g., hydroxypropyl guar), cellulose, or other gelling agents, which may or may not be crosslinked using one or more crosslinkers, such as polyvalent metal ions or borate anions, among other suitable crosslinkers. However, because of the low densities of the thermally post-treated delayed coke proppant particulates described herein, such viscosity-altering additives can typically be avoided, thus reducing costs and reducing potential damage to the wellbore.

In some instances, the carrier fluid used in hydraulic fracturing of horizontal wells is one or more of an aqueous-based fluid type, particularly in light of the large volumes of fluid typically required for hydraulic fracturing. The aqueous-based fluid may or may not be gelled, as described above. In some instances, the fracturing fluid may comprise an aqueous-based carrier fluid, which may or may not be foamed or gelled, and an acid (e.g., HCl) to further stimulate and enlarge pore areas of the matrix of fracture surfaces.

In addition, certain fracturing fluids suitable for use in the present disclosure may contain one or more additives such as, for example, dilute aids, biocides, breakers, corrosion inhibitors, crosslinkers, friction reducers (e.g., polyacrylamides), gels, salts (e.g., KCl), oxygen scavengers, pH control additives, scale inhibitors, surfactants, weighting agents, inert solids, fluid loss control agents, emulsifiers, emulsion thinners, emulsion thickeners, viscosifying agents, particulates, lost circulation materials, foaming agents, gases, buffers, stabilizers, chelating agents, mutual solvents, oxidizers, reducers, clay stabilizing agents, and any combination thereof.

The present disclosure includes methods of hydraulic fracturing using a fracturing fluid comprising thermally post-treated delayed coke proppant particulates, alone or in combination with other proppant particulates, during a hydraulic fracturing operation. That is, the thermally post-treated delayed coke proppant particulates may form the entirety of a proppant pack, or may form an part of a proppant pack. Other proppant particulate types that may be utilized with the thermally post-treated delayed coke proppant particulates described herein include, but are not limited to, the traditional sand proppant particulates described herein, as well as those made from bauxite, ceramic, glass, fluid coke, flexicoke, and any combination thereof, and may or may not have surface modifications. Proppant particulates composed of other materials are also within the scope of the present disclosure, provided that any such selected proppant particulates (including those composed of the aforementioned materials) are able to maintain their integrity upon removal of hydraulic pressure within an induced fracture, such that about 80%, preferably about 90%, and more preferably about 95% or greater of the particulate mass of the other proppant particulates retains integrity when subjected to 5000 psi of stress, a requirement also met by the thermally post-treated delayed coke proppant particulates of the present disclosure. That is, both the thermally post-treated delayed coke proppant particulates and any other proppant particulates used in the methods described herein must maintain mechanical integrity upon fracture closure, as any such types of particulates must intermingle or otherwise associate to form functional proppant packs for a successful hydraulic fracturing operation.

The methods described herein include preparation of fracturing fluid, which is not considered to be particularly limited, because the thermally post-treated delayed coke proppant particulates are capable of transportation in dry form or as part of a wet slurry from a manufacturing site (e.g., a refinery or synthetic fuel plant). Dry and wet forms may be transported via truck or rail, and wet forms may further be transported via pipelines. The transported dry or wet form of the thermally post-treated delayed coke proppant particulates may be added to a carrier fluid, including optional additives, at a production site, either directly into a wellbore or by pre-mixing in a hopper or other mixing equipment. In some aspects, for example, when the entirety of the proppant particulates within the fracturing fluid at a given time are thermally post-treated delayed coke proppant particulates, slugs of the dry or wet form may be added directly to the fracturing fluid (e.g., as it is introduced into the wellbore). These slugs of only thermally post-treated delayed coke proppant particulates may be followed by subsequent slugs of, again, only thermally post-treated delayed coke proppant particulates or of a thermally post-treated delayed coke proppant particulates and other proppant particulates. In other aspects, such as when other proppant particulate types are combined with the flexicoke proppant particulates, a portion or all of the fracturing fluid may be pre-mixed at the production site or each proppant type may be added directly to the fracturing fluid separately. Any other suitable mixing or adding of the thermally post-treated delayed coke proppant particulates to produce a desired fracturing fluid composition may also be used, without departing from the scope of the present disclosure.

The methods of hydraulic fracturing suitable for use in one or more aspects of the present disclosure involve pumping fracturing fluid comprising thermally post-treated delayed coke proppant particulates at a high pump rate into a subterranean formation to form at least a primary fracture, as well as potentially one or more secondary fractures extending from the primary fracture, one or more tertiary fractures extending from the secondary fractures, and the like (all collectively referred to as a “fracture”). In a preferred aspect, this process is conducted one stage at a time along a well. The stage is hydraulically isolated from any other stages which have been previously fractured. In one embodiment, the stage being fractured has clusters of perf holes (e.g., perforations in the wellbore and/or subterranean formation) allowing flow of hydraulic fracturing fluid through a metal tubular casing of the well into the formation. Such metal tubular casings are installed as part of the completions when the well is drilled and serve to provide mechanical integrity for the well. In some aspects, the pump rate for use during hydraulic fracturing may be at least about 20 barrels per minute (bbl/min), preferably about 30 bbl/min, and more preferably in excess of 50 bbl/min and less than 1000 bbl/min at one or more time durations during the fracturing operation (e.g., the rate may be constant, steadily increased or pulsed). These high rates may, in some aspects, be utilized after about 10% of the entire volume of fracturing fluid to be pumped into the formation has been injected. That is, at the early periods of a hydraulic fracturing operation, the pump rate may be lower and as fracture(s) begin to form, the pump rate may be increased. Generally, the average pump rate of the fracturing fluid throughout the operation may be about 10 bbl/min, preferably about 15 bbl/min, and more preferably in excess of 25 bbl/minute and less than 250 bbl/min. Typically, the pump rate during a fracturing operation for more than 30% of the time required to complete fracturing of a stage is in the range of about 20 bbl/min to about 150 bbl/min, or about 40 bbl/min to about 120 bbl/min, or about 40 bbl/min to about 100 bbl/min.

In various aspects, the methods of hydraulic fracturing described herein may be performed wherein the concentration of the proppant particulates (including thermally post-treated delayed coke proppant particulates and any other proppant particulates) within the injected fracturing fluid is altered (i.e., on-the-fly while the fracturing operation is being performed, such that hydraulic pressure is maintained within the formation and fracture(s)). For example, in some aspects, the initially injected fracturing fluid may be injected at a low pump rate and may comprise 0 volume % (vol. %) to about 1 vol. % proppant particulates. As one or more fractures begin to form and grow, the pump rate is increased and the concentration of proppant particulates may be increased in a stepwise fashion (with or without a stepwise increase in pump rate) with a maximum concentration of proppant particulates reaching about 2.5 vol. % to about 20 vol. %, encompassing any value and subset therebetween. For example, the maximum concentration of proppant particulates may reach at least 2.5 vol. %, preferably about 8 vol. %, and more preferably about 16 vol. %. In some aspects, all of the proppant particulates are thermally post-treated delayed coke proppant particulates. In other aspects, at one or more time periods during the hydraulic fracturing operation, at least about 2 vol. % to about 100 vol. % of any proppant particulates suspended within the fracturing fluid are thermally post-treated delayed coke proppant particulates, such as at least about 2 vol. %, preferably about 15 vol. %, more preferably about 25 vol. %, and even more preferably 100 vol. %.

It should be noted that some or all of the thermally post-treated delayed coke proppant particulates may be coated. Coatings are often used on sand particles used in hydraulic fracturing to either improve their flowability or to mitigate their flow back during production. Such types of coatings are within the scope of this invention. It is possible to introduce coated thermally post-treated delayed coke proppant particulates at any stage of the hydraulic fracturing process with the resulting composition being either a mixture of coated and uncoated thermally post-treated delayed coke proppant particulates, or entirely coated thermally post-treated delayed coke proppant particulates.

In one or more aspects, the thermally post-treated delayed coke proppant particulates may be introduced after about ⅛ to about ¾ of the total volume of fracturing fluid has been injected within a formation. Because of the low density of the thermally post-treated delayed coke proppant particulates, it may be beneficial to introduce the thermally post-treated delayed coke proppant particulates during later time periods of fracturing after which the fracture(s) have already grown substantially, such that the thermally post-treated delayed coke proppant particulates can travel within the fracturing fluid to remote locations of the formed fracture(s). Denser proppant particulates would not be able to reach these remote locations due to settling effects, for example.

The hydraulic fracturing methods described herein may be performed in drilled horizontal, vertical, or tortuous wellbores, hydrocarbon-producing (e.g., oil and/or gas) wellbores and water-producing wellbores. These wellbores may be in various subterranean formation types including, but not limited to, shale formations, sandstone formations, oil sands, gas sands, and the like.

The wellbores are typically completed using a metal (e.g., steel) tubular or casing that is cemented into the subterranean formation. To contact the formation, a plurality of perforations is created through the tubular and cement along a section to be treated, usually referred to as a plug and perforated (“plug and perf”) cased-hole completion. Alternative completion techniques may be used without departing from the scope of the present disclosure, but in each technique, a finite length of the wellbore is exposed for hydraulic fracturing and injection of fracturing fluid. This finite section is referred to herein as a “stage.” In plug and perf completions, the stage length may be based on a distance over which the tubular and cement have been perforated, and may be in the range of about 10 feet (ft) to about 2000 ft, for example, and more generally in the range of about 100 ft to about 300 ft, encompassing any value and subset therebetween. The stage is isolated (e.g., sliding sleeve, ball) such that pressurized fracturing fluid from the surface can flow through the perforations and into the formation to generate one or more fractures in only the stage area. Clusters of perforations may be used to facilitate initiation of multiple fractures. For example, clusters of perforations may be made in sections of the stage that are about 1 ft to about 3 ft in length, and spaced apart by about 2 ft to about 30 ft, encompassing any value and subset therebetween.

For each linear foot of the stage, at least about 6 barrels (about 24 cubic feet (ft³)), preferably about 24 barrels (about 135 ft³), and more preferably at least 60 barrels (about 335 ft³) and less than 6000 barrels (about 33,500 ft³) of fracturing fluid may be injected to grow the one or more fractures. In certain aspects, for each linear foot of the stage, at least about 1.6 ft³, preferably about 6.4 ft³, and more preferably at least 16 ft³ and less than 1600 ft³ of proppant particulates may be injected to prop the fractures. In some aspects, to prevent bridging of the proppant particulates during injection into the fractures, the ratio of the volume of the proppant particulates to the liquid portion of the fracturing fluid, primarily the carrier fluid, is greater than 0 and less than about 0.25 and preferably less than about 0.15. If the volume ratio becomes too large a phenomenon known as “sanding out” will occur.

Certain commercial operations, such as commercial shale fracturing operations, may be particularly suitable for hydraulic fracturing using the thermally post-treated delayed coke proppant particulates and methods described herein, as the mass of proppant particulates required per stage in such operations can be quite large and substantial economic benefit may be derived using the delayed coke proppant particulates. The cost of delayed coke as a source for the thermally post-treated delayed coke proppant particulates can be less than the cost of sand, and significantly less than lower density proppant particulates, which provide a significant economic benefit. Indeed, in some instances, a stage in a shale formation may be designed to require at least about 30,000, preferably about 100,000, and more preferably about 500,000 pounds (mass) of proppant particulates. In such cases, economic and performance benefit may be optimized when at least about 5%, preferably more than about 25%, and up to 100% of the proppant particulate mass comprises thermally post-treated delayed coke proppant particulates.

Multiple stages of the wellbore are isolated and hydraulic fracturing performed at each stage. The thermally post-treated delayed coke proppant particulates of the present disclosure may be used in any one, more, or all more stages, including at least 2 stages, preferably at least 10 stages, and more preferably at least 20 stages.

### Example Embodiments

Nonlimiting example embodiments of the present disclosure include:

E1. Proppant particulates, comprising:
first proppant particulates comprising delayed coke that has been thermally post-treated to a temperature in a range of about 400° C. to about 1000° C.

E2. The proppant particulates of E1, wherein the first proppant particulates consists essentially of delayed coke that has been thermally post-treated to a temperature in a range of about 400° C. to about 1000° C.

E3. The proppant particulates of E1 or E2, wherein the first proppant particulates have a D50 in the range from about 88 microns to about 250 microns.

E4. The proppant particulates of any of E1 to E3, wherein at least 50 vol % of the first proppant particulates have particle sizes in a range from about 88 microns to about 250 microns.

E5. The proppant particulates of any of E1 to E4, wherein at least 80 vol % of the first proppant particulates have particle sizes in a range from about 88 microns to about 250 microns.

E6. The proppant particulates of any of E1 to E5, wherein the first proppant particulates were thermally post-treated for a predetermined duration that is in a range of about 15 minutes to about 24 hours.

E7. The proppant particulates of any of E1 to E6, wherein the first proppant particulates were thermally post-treated for a predetermined duration that is in a range of about 15 minutes to about 8 hours.

E8. The proppant particulates of any of E1 to E7, wherein the first proppant particulates were thermally post-treated for a predetermined duration that is in a range of about 15 minutes to about 4 hours.

E9. The proppant particulates of any of E1 to E8, wherein the first proppant particulates have an apparent density in a range of about 1.2 g/cm³ to about 2.1 g/cm³.

E10. The proppant particulates of any of E1 to E9, wherein the first proppant particulates have an apparent density in a range of about 1.4 g/cm³ to about 1.6 g/cm³.

E11. The proppant particulates of any of E1 to E10, wherein the first proppant particulates have a bulk density of less than about 0.8 g/cm³.

E12. The proppant particulates of any of E1 to E11, wherein the first proppant particulates have a bulk density of less than about 0.7 g/cm³.

E13. The proppant particulates of any of E1 to E12, wherein the first proppant particulates have a reduced elastic modulus in a range of about 5 gigapascals to about 50 gigapascals.

E14. The proppant particulates of any of E1 to E13, wherein the first proppant particulates have a hardness value in a range of about 1 gigapascal to about 4 gigapascals.

E15. The proppant particulates of any of E1 to E14, wherein the first proppant particulates have a weight ratio of carbon to hydrogen of about 50:1 to about 120:1.

E16. The proppant particulates of any of E1 to E15, wherein the first proppant particulates have a percent of degradables as determined by thermogravimetric analysis in a range of up to about 3%.

E17. Proppant particulates, comprising:
first proppant particulates having a D50 in a range from about 88 microns to about 250 microns and comprising delayed coke that has been thermally post-treated.

E18. The proppant particulates of E17, wherein at least 50 vol % of the first proppant particulates have particle sizes in a range from about 88 microns to about 250 microns.

E19. The proppant particulates of E17 or E18, wherein at least 80 vol % of the first proppant particulates have particle sizes in a range from about 88 microns to about 250 microns.

E20. The proppant particulates of any of E17 to E19, wherein the delayed coke has been thermally post-treated for a duration of about 15 minutes to about 24 hours.

E21. The proppant particulates of any of E17 to E20, wherein the first proppant particulates have an apparent density in a range of about 1.2 g/cm³ to about 2.1 g/cm³.

E22. The proppant particulates of any of E17 to E21, wherein the first proppant particulates have an apparent density in a range of about 1.4 g/cm³ to about 1.6 g/cm³.

E23. The proppant particulates of any of E17 to E22, wherein at least one of the following is met:
the first proppant particulates have a bulk density of less than about 0.8 g/cm³,
the delayed coke has a sulfur content in a range of about 1 weight percent (wt. %) to about 8 wt. %,
the delayed coke has a volatile matter content in a range of about 8 wt. % to about 15 wt. %, and
the delayed coke has a Hargrove grindability index in a range of about 30 to about 130.

E24. The proppant particulates of any of E17 to E23, wherein the first proppant particulates comprise delayed coke that has been thermally post-treated to a temperature in a range of about 400° C. to about 1000° C.

E25. Proppant particulates, comprising:
first proppant particulates comprising delayed coke and having a bulk density of less than about 0.8 g/cm³.

E26. The proppant particulates of E25, wherein the first proppant particulates have a bulk density of less than about 0.7 g/cm³.

E27. The proppant particulates of E25 or E26, wherein the delayed coke has been thermally post-treated to a temperature in a range of about 400° C. to about 1000° C.

E28. The proppant particulates of any of E25 to E27, having a D50 in a range from about 88 microns to about 250 microns.

E29. The proppant particulates of any of E25 to E28, wherein at least 50 vol % of the first proppant particulates have particle sizes in a range from about 88 microns to about 250 microns.

E30. The proppant particulates of any of E25 to E29, wherein at least 80 vol % of the first proppant particulates have particle sizes in a range from about 88 microns to about 250 microns.

E31. The proppant particulates of any of E25 to E30, wherein the first proppant particulates were thermally post-treated for a predetermined duration that is in a range of about 15 minutes to about 24 hours.

E32. The proppant particulates of any of E25 to E31, wherein the delayed coke has a sulfur content in a range of about 1 weight percent (wt. %) to about 8 wt. %.

E33. The proppant particulates of any of E25 to E32, wherein the delayed coke has a volatile matter content in a range of about 8 wt. % to about 15 wt. %.

E34. The proppant particulates of any of E25 to E33, wherein the delayed coke has a Hargrove grindability index in a range of about 30 to about 130.

E35. A method for producing proppant particulates, the method comprising:
(a) providing a precursor material comprising delayed coke;
(b) heating the precursor material at a temperature in a range from about 400° C. to about 1200° C. for a predetermined duration to obtain heat treated precursor material; and
(c) obtaining the proppant particles from the heat treated precursor material.

E36. The method of E35, wherein step (a) comprises:
(a1) providing a delayed coke material;
(a2) grinding and/or sieving the delayed coke material to obtain the precursor material.

E37. The method of E35 or E36, wherein step (c) comprises:
(c1) grinding and/or sieving the heat treated precursor material to obtain the proppant particles.

E38. The method of any of E35 to E37, wherein in step (a), the precursor material is green delayed coke.

E39. The method of E37, wherein step (c1) comprises grinding and/or sieving the heat treated precursor material to have a D50 in a range from 88 microns to 250 microns.

E40. The method of any of E35 to E39, wherein at least 50 vol % of the proppant particles have particle sizes in a range from about 88 to about 250 microns.

E41. The method of any of E35 to E40, wherein at least 80 vol % of the proppant particles have particle sizes in a range from about 88 to about 250 microns.

E42. The method of any of E35 to E41, wherein step (b) is carried out at a temperature from about 400° C. to about 1050° C. for the predetermined duration of 15 minutes to 15 hours.

E43. The method of any of E35 to E42, wherein step (b) is carried out at a temperature from about 400° C. to about 800° C.

E44. The method of any of E35 to E43, wherein step (b) is carried out at a temperature from about 600° C. to about 800° C.

E45. The method of any of E35 to E44, wherein step (b) is carried out for the predetermined duration of about 15 minutes to about 8 hours.

E46. The method of any of E35 to E45, wherein step (b) is carried out for the predetermined duration of about 15 minutes to about 4 hours.

E47. A fracturing fluid comprising: a carrier fluid; and thermally post-treated delayed coke proppant particulates, wherein the thermally post-treated delayed coke proppant particulates comprise delayed coke that has been thermally post-treated to a temperature in the range of about 400° C. to about 1000° C. for a predetermined duration and ground to a predetermined average size diameter in either order.

E48. The fracturing fluid of E47, wherein the predetermined duration is in the range of about 15 minutes to about 24 hours.

E49. The fracturing fluid of E47 or E48, wherein the predetermined average particle size distribution is in the range of about 100 micrometers to about 600 micrometers.

E50. The fracturing fluid of any of E47 to E49, wherein the thermally post-treated delayed coke proppant particulates have apparent density in the range of about 1.4 g/cm³ to about 2.1 g/cm³.

E51. The fracturing fluid of any of E47 to E49, wherein the thermally post-treated delayed coke proppant particulates have a bulk density of less than about 0.7 g/cm³.

E52. The fracturing fluid of any of E47 to E51, wherein the thermally post-treated delayed coke proppant particulates have a reduced elastic modulus in the range of about 5 gigapascals to about 50 gigapascals.

E53. The fracturing fluid of any of E47 to E52, wherein the thermally post-treated delayed coke proppant particulates have a hardness value in the range of about 1 gigapascal to about 4 gigapascals.

E54. The fracturing fluid of any of E47 to E53, wherein the thermally post-treated delayed coke proppant particulates have a weight ratio of carbon to hydrogen of about 50:1 to about 120:1.

E55. The fracturing fluid of any of E47 to E54, wherein the thermally post-treated delayed coke proppant particulates have a percent of degradables as determined by thermogravimetric analysis in the range of about 0% to about 3%.

E56. A method comprising: introducing a fracturing fluid into a subterranean formation, the fracturing fluid comprising a carrier fluid and thermally post-treated delayed coke proppant particulates, wherein the thermally post-treated delayed coke proppant particulates comprise delayed coke that has been thermally post-treated to a temperature in the range of about 400° C. to about 1000° C. for a predetermined duration and ground to a predetermined average size diameter in either order.

E57. The method of E56, further comprising prior to introducing the fracturing fluid into the subterranean formation, removing at least a portion of fines having an average particle size distribution of less than about 20 micrometers.

E58. The method of E56 or E57, further comprising depositing at least a portion of the thermally post-treated delayed coke proppant particulates within one or more fractures in the subterranean formation to form a proppant pack.

E59. The method of any of E56 to E58, wherein the predetermined duration is in the range of about 15 minutes to about 24 hours.

E60. The method of any of E56 to E59, wherein the predetermined average particle size distribution in the range of about 100 micrometers to about 600 micrometers.

E61. The method of any of E56 to E60, wherein the thermally post-treated delayed coke proppant particulates have apparent density in the range of about 1.4 g/cm³ to about 2.1 g/cm³.

E62. The method of any of E56 to E60, wherein the thermally post-treated delayed coke proppant particulates have a bulk density of less than about 0.7 g/cm³.

E63. The method of any of E56 to E62, wherein the thermally post-treated delayed coke proppant particulates have a reduced elastic modulus in the range of about 5 gigapascals to about 50 gigapascals.

E64. The method of any of E56 to E63, wherein the thermally post-treated delayed coke proppant particulates have a hardness value in the range of about 1 gigapascal to about 4 gigapascals.

E65. The method of any of E56 to E64, wherein the thermally post-treated delayed coke proppant particulates have a weight ratio of carbon to hydrogen of about 50:1 to about 120:1.

E66. The method of any of E56 to E65, wherein the thermally post-treated delayed coke proppant particulates have a percent of degradables as determined by thermogravimetric analysis in the range of about 0% to about 3%.

Any combination of E47 to E50 and E52 to E55 are within the scope of the present disclosure, without limitation. Any combination of Embodiments E47 to E49 and E51 to E55 are within the scope of the present disclosure, without limitation.

Any combination of E56 to E62 and E63 to E66 are within the scope of the present disclosure, without limitation. Any combination of Embodiments E47 to E60 and E62 to E66 are within the scope of the present disclosure, without limitation.

To facilitate a better understanding of the aspects of the present disclosure, the following examples of preferred or representative aspects are given. In no way should the following examples be read to limit, or to define, the scope of the disclosure.

### EXAMPLES

In the following examples, various experiments were performed and measurements taken to evaluate and validate the thermal post-treatment methodology of delayed coke described herein, such that the treated delayed coke exhibits mechanical properties suitable for use as proppant particulates during hydraulic fracturing operations.

### Example 1: Fracture Conductivity Comparison

In this Example, the fracture conductivities of 100-mesh samples of a sand control (CT1), a fluid coke (FC1), a flexicoke (FX1), and two shot coke (representing delayed coke) samples were gathered from separate sources (DC1 and DC2). Each of DC1 and DC2 were ground to obtain the 100-mesh samples.

Fracture conductivity was determined using proppant packs sandwiched between Ohio sandstone cores with a proppant particulate loading of 2 pounds per square foot (lb/ft²) of fracture surface. The system was allowed to relax under 1000 pounds per square inch (psi) of confining stress at 150° F. (65.6° C.) and the proppant pack permeability was measured by cross flowing a 2% aqueous KCl solution under a small pressure gradient. The permeability was multiplied by the pack height and reported as the fracture conductivity, as measured in millidarcy feet (mD-ft).

During the testing, the applied stress (closure stress) was incremented in 2000 psi intervals from 2000 psi to 8000 psi, and the system was allowed to relax for 50 hours before determining the conductivity at the stress level of interest. FIG. 2 illustrates a chart representing the results of the fracture conductivities. As shown, the fluid coke (FC1) and flexicoke (FX1) samples had conductivity characteristics similar to that of control sand (CT1) typically used in hydraulic fracturing operations; however, both shot coke samples (DC1 and DC2) exhibited inferior characteristics, particularly at higher closure stresses. Note that the asterisk represents the minimum recommended fracture conductivity at 6000 psi closure stress.

### Example 2: Influence on Grinding (Milling) and Fines on Fracture Conductivity

In this Example, the relative importance of grinding, particle shape, and fines characteristics of proppant particulates on fracture conductivity was evaluated. In this Example, a fluid coke sample (FC2) and a traditional sand sample (CT2) were compared. Each sample was tested at (1) 40/70 mesh (without grinding), (2) 100 mesh (without grinding), (3) 100 mesh (after grinding the 40/70 mesh sample with a high speed rotary mill and isolating the portion of the sample between 70/100 mesh, and (4) after removal of fines through elutriation of the ground 100 mesh sample (from (3)). The results are shown in FIG. 4.

As shown, the neat 40/70 mesh (without grinding) samples exhibit higher conductivity than the corresponding neat 100 mesh (without grinding) samples. The 100 mesh (after grinding but without sieving) samples show lower conductivity and a higher level of stress-dependence- and conductivity loss—compared to the neat 100 mesh (without grinding) samples. However, upon fines removal from the ground 100 mesh samples, the FC2 sample showed fracture conductivity similar to the neat 100 mesh (without grinding) sample, and the CT2 sample showed fracture conductivity similar to the neat 40/70 mesh (without grinding) sample. Accordingly, the removal of fines from the ground samples shows improvement in fracture conductivity.

### Example 3: Influence on Size and Shape on Fracture Conductivity

In this Example, the proppant particulate size and shape distribution of FC2 (fluid coke) and CT2 (traditional sand) of Example 2 were characterized using automated digital imaging microscopy to measure the cumulative distribution function statistics for circular equivalent diameter. Particularly, each of FC2 and CT2 were evaluated using the samples: (2) 100 mesh (without grinding), (3) 100 mesh (after grinding the 40/70 mesh sample with a high speed rotary mill and isolating the portion of the sample between 70/100 mesh, and (4) after removal of fines through elutriation of the ground 100 mesh sample (from (3)) of Example 2; that is, the 40/70 mesh (without grinding) sample (1) of Example 2 was not evaluated in this Example.

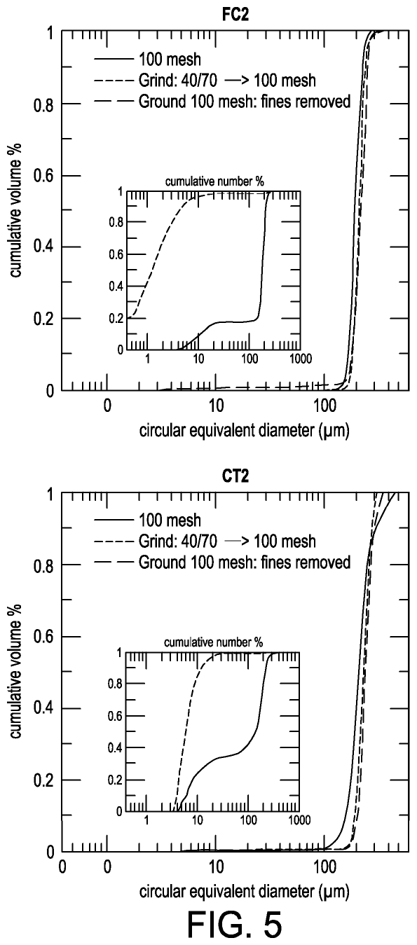

The results of proppant particulate size distribution are shown in FIG. 5, providing volumetric weighted statistics in the large chart and corresponding particle number weighted distributions in the inset. As shown, very little difference is observed in the overall distribution among each of the 100 mesh samples for both FC2 and CT2; however, when the distributions are examined on particle number basis, as shown in the inset of FIG. 5, it can be seen that a large number fraction of the sample is comprised of very small particles of <20 microns in equivalent diameter. Moreover, as shown, while the vast majority of the mass of each of the FC2 and CT2 samples reside in the 100 mesh range, upon comparison of the neat 100 mesh (without grinding) samples with the 100 mesh (after grinding but without sieving), it is evident that the ground samples have significantly greater fines content, and thus a negative impact upon overall fracture conductivities.

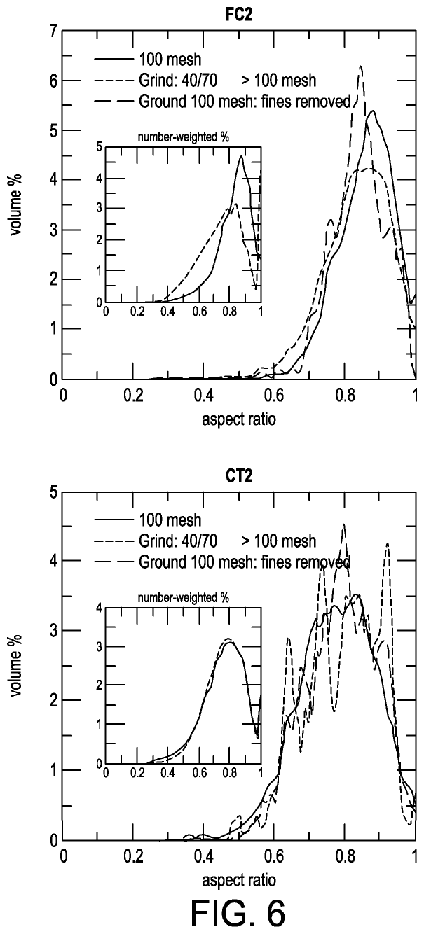

The results of the proppant particulate shape distribution are shown in FIG. 6 providing volumetric weighted statistics in the large chart and corresponding particle number weighted distributions in the inset. As shown, on a volumetric basis, the shape of the proppant particulates, if any, would have a minimal influence on fracture conductivity, as the aspect ratios are relatively similar across all 100 mesh samples for both FT2 and CT2. However, as with the size distribution discussed above, upon comparison of the neat 100 mesh (without grinding) samples with the 100 mesh (after grinding but without sieving) samples, it is evident that the ground samples have a larger number of proppant particulates having a smaller aspect ratio (inset of FIG. 6) due to the presence of fines. Accordingly, it is inferred that fines removal after grinding has a larger impact upon fracture conductivity than the shape of the proppant particulates themselves (see also FIG. 4).

### Example 4: Effect of Thermal Post-Treatment

In this Example, the effect of the thermal post-treatment methods of the present disclosure were evaluated based on several criteria. Two shot coke (representing delayed coke) samples derived from the same sources as Example 1, DC1 and DC2, were evaluated and compared to the fluid coke sample of Example 1, FC2, and/or the traditional sand of Examples 2 and 3, CT2. The properties of each sample type were evaluated as a function of severity of the thermal post-treatment processing described herein. Each sample was heated in a tube furnace to a target temperature, as described below, held for 1 hour, and allowed to fully cool before removal. The samples were immersed in a N₂ gas flow to achieve pyrolysis conditions during the heat treatment. Thereafter, the samples were evaluated.

### C/H Ratio and TGA

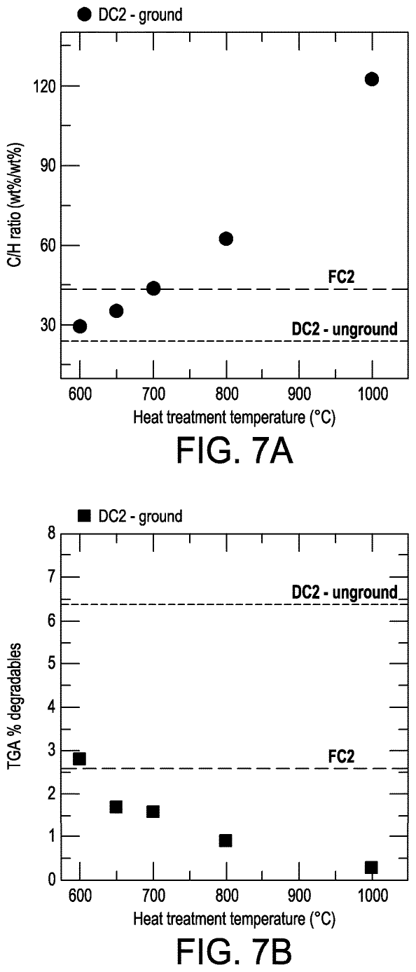

In this Example, heat-treated samples of DC2 were analyzed for compositional indicators expected to evolve as a function of heat treatment. The C/H ratio of the heat-treated samples were measured by Inductively Coupled Plasma Atomic Emission Spectroscopy (ICP-AES), and the volatile matter content was characterized by Thermogravimetric Analysis (TGA). In the TGA method applied here, a small quantity of sample is immersed in flowing N₂, and subjected to a defined temperature ramp from room temperature to 800° C., whereby volatile components of the sample are liberated by a variety of mechanisms. The volatile matter, or % degradables as shown in FIG. 7B, is defined as the mass loss of the sample between 110° C. to 1000° C. The results are shown in FIGS. 7A and 7B, respectively, wherein the results for samples heat treated at hold-temperatures between 600° C. and 1000° C. are shown compared to the baseline value of the fluid coke, and where the dotted lines demonstrate the C/H ratio or TGA of unground DC2 and FC2 without heat treatment (as-received) and thus do not correlate to the temperature increase.

As shown, in FIG. 7A, the C/H ratio of the ground DC2 increases steadily with heat treatment as volatiles are liberated from the material, with comparable levels to FC2 achieved around 700° C. FIG. 7B shows a continuous decrease in volatile matter content remaining in the samples after heat treatment, with ground DC2 dropping below the FC2 levels at heat treatments between about 600° C. and 650° C. It is also worth noting that the ground DC2 weight loss during thermal treatment was fairly small, ranging from about 3.3 wt. % at 600° C. to about 8.9 wt. % at 800° C.

Accordingly, with increasing temperature, delayed coke can achieve equivalent or better C/H ratio and TGA % degradables compared to fluid coke (and flexicoke).

### Apparent Density

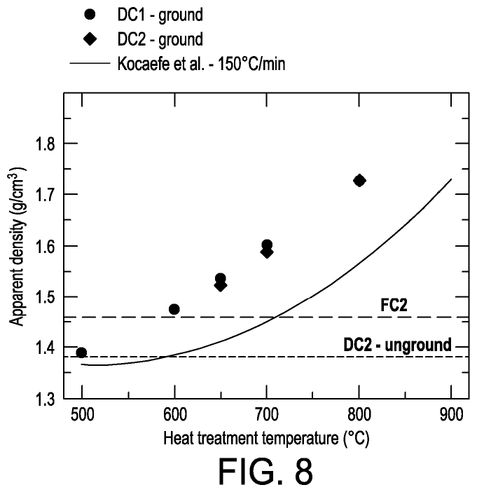

In this Example, we demonstrate that only a modest apparent density increase is associated with the heat-treatment of the previous Example. The apparent density of 40/70 mesh ground DC1 and ground DC2 samples were evaluated using He pycnometry after heat-treatment at hold temperatures between 50° and 800° C. and compared to as-received DC2 and FC2. The results are shown in FIG. 8, wherein the results between 600° C. and 800° C. are shown based on the baseline value of the fluid coke, and where the horizontal dotted lines demonstrate the apparent densities of as-received DC2 and FC2 without heat treatment and thus do not correlate to the temperature increase. As a further comparison, the sloped dotted line shows the apparent density of a commercial 3.2 wt. % S petroleum coke heated to a target temperature at 150° C./min, as reported in D. Kocaefe, A. Charette, and L. Castonguay, Green coke pyrolysis: investigation of simultaneous changes in gas and solid phases, Fuel, 74(6): 791-799, 1995.

The apparent density of ground DC1 and DC2 begin to increase above 500° C., increasing by about 15% at 700° C. Comparing ground DC1 and ground DC2, the heat-treated shot cokes show unappreciable differences in the behavior despite being derived from two separate sources. Compared to FC2, the apparent densities of the ground DC1 and ground DC2 samples cross over at approximately 600° C. Moreover, the thermal post-treatment process of the present disclosure compared to the commercial 3.2 wt. % S petroleum coke data illustrates the influence of heating rate and overall thermal severity of the heat-treatment process. Typical calcination of green petroleum cokes for use in anode manufacture will reach 1300° C. and achieve apparent densities of approximately 2.1 g/cm³ and loss of 15 to 25 wt. % of material on a dry basis. Because it is desirable to have low density proppant particulates, it is apparent that heat-treatment in the range of 700° C. incurs only modest density increase and loss of material.

### Nanoindentation

In this Example, the mechanical properties of thermal post-treatment shot coke (representing delayed coke) samples of DC2, ground to 100-mesh and heat treated between 600° C. and 1000° C. (at 1 hour or 4 hour durations) are compared to a traditional sand, CT3, the fluid coke sample of Example 1, FC1, and an epoxy to which the samples were mounted, as described below.

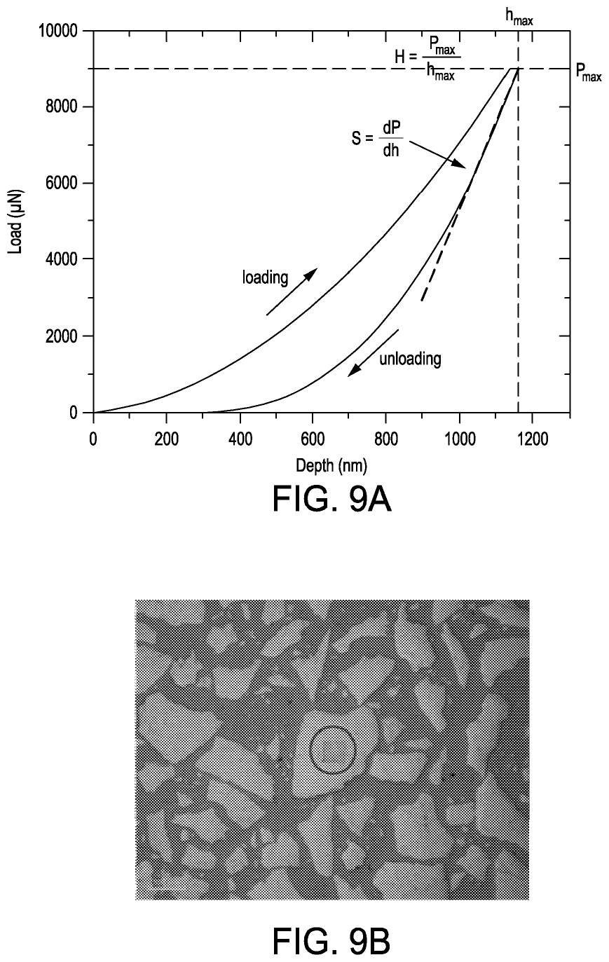

Samples were cast in epoxy in the form of 1-inch diameter billets, and polished smooth to expose flat grain surfaces (cross-section surfaces) for indentation. Nanoindentation was performed using a nanoindenter equipped with a diamond Berkovich tip as described above, and as illustrated in FIG. 9A. At each temperature, ten (10) different proppant particulates were sampled to collect statistics on average modulus and hardness properties, as well as their standard deviations. FIG. 9B shows a residual indentation formed on a DC2 shot coke sample according to the present Example.

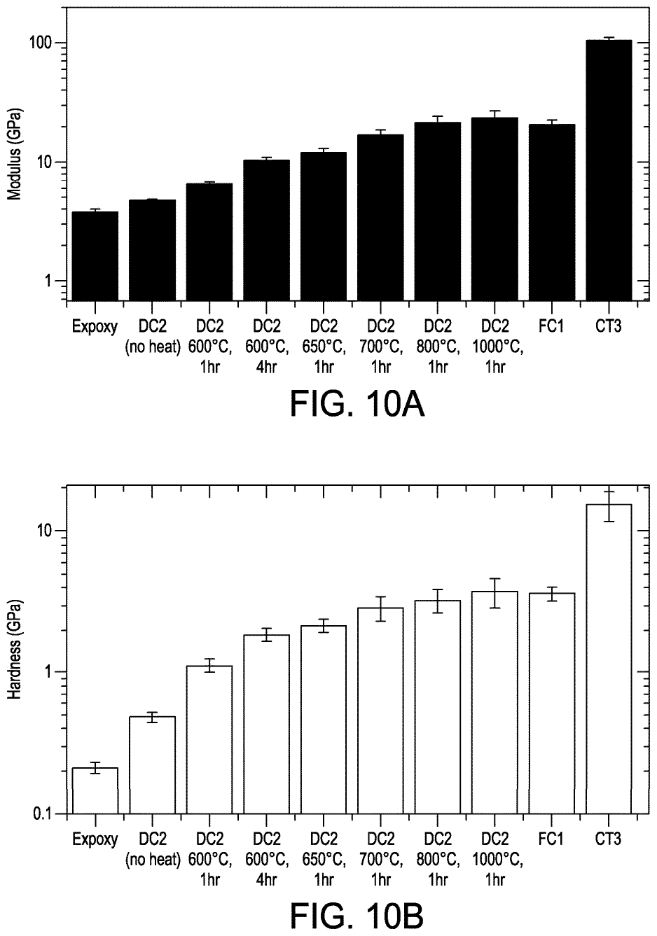

The nanoindentation results are shown in FIGS. 10A and 10B, where FIG. 10A shows the reduced elastic modulus results and FIG. 10B shows the hardness results.

As shown in FIG. 10A, the DC2 sample that has not been thermally post-treated (as-received) is similar to that of epoxy alone, having a modulus of 3-4 gigapascals (Gpa). As temperature increases, or duration of the same temperature increases, the modulus increases to values similar to FC1 fluid coke, achieving parity between about 700° C. and 800° C. Heat treatment to higher temperatures does not appear to significantly increase modulus. While the thermally post-treatment heated DC2 samples have a lesser modulus compared to CT3 traditional sand, it does exhibit comparable modulus to FC1 which is a demonstrated material for proppant particulate use during fracturing operations.

Referring now to FIG. 10B, the DC2 sample that has not been thermally post-treated (as-received) exhibits roughly twice the hardness compared to that of epoxy alone, having a hardness of about 0.2 Gpa. Similar to modulus, as heat-treatment temperature increases, or duration of the same temperature increases, the hardness of the DC2 heat treated samples increase to values similar to FC1 fluid coke, achieving parity between about 700° C. and 800° C. Heat treatment to higher temperatures does not appear to significantly increase hardness, although a slight increase was observed. While the heat-treated DC2 samples have a lesser hardness compared to CT3 traditional sand, it does exhibit comparable hardness to FC1 which is a demonstrated material for proppant particulate use during fracturing operations.

### Uniaxial Compression

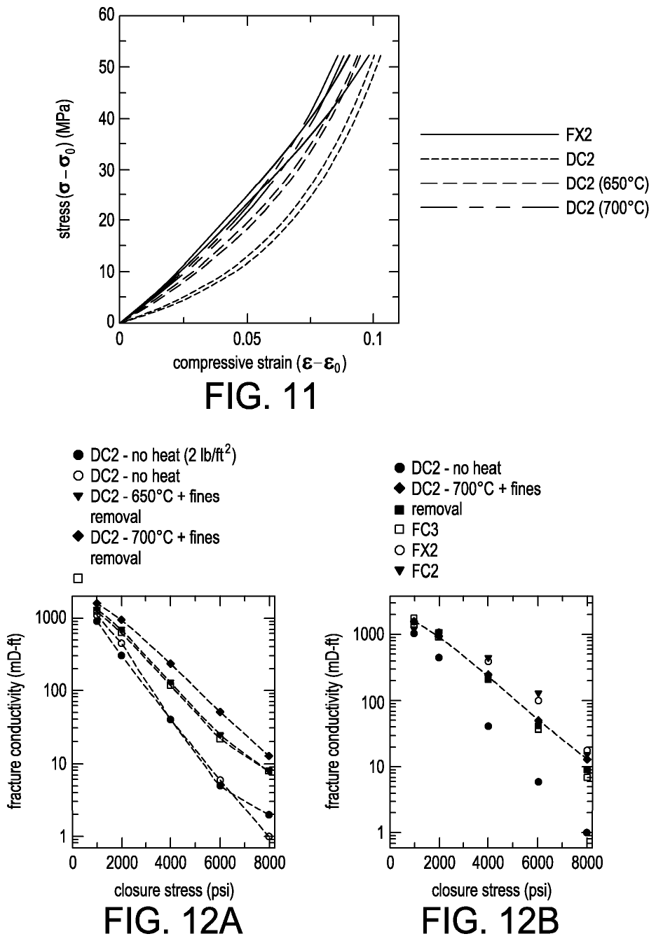

In this Example, shot coke (representing delayed coke) samples described above were subjected to uniaxial compression using a pellet die compression test. Approximately 1 gram of each sample was loaded into a 0.5-inch diameter pellet die, and tamped down prior to compression in an INSTRON® (Norwood, MA) load frame. The samples were compressed at a rate of 0.15 millimeters per minute (mm/min) to 7500 Newton (N) (approximately 8600 psi). The stress-strain curves for various shot coke 40/70 mesh samples are shown in FIG. 11, where the curves have been shifted to the reference state at which the applied stress is 1000 psi. DC2 was 40/70 mesh and two DC2 samples were thermally post-treated at 650° C. and 700° C.; each were tested in duplicate. As shown in FIG. 11, the thermally post-treated DC2 samples demonstrated elevated compression (greater stiffness) compared to counterparts that were not thermally post-treated. Sample FX2 is a 40/70 mesh sample of flexicoke, which is shown for comparison. It can be seen that the overall compression behavior of the heat-treated shot coke (delayed coke) samples is very similar to that of the flexicoke sample.

### Fracture Conductivity

In this Example, the fracture conductivities of 40/70 mesh samples of a shot coke (representing delayed coke) (DC2) were examined having various thermal post-treatments and/or fines removal (labeled “+ fines removal” in FIGS. 12A and 12B) and compared to samples that were neither thermally treated nor having fines removal.

Fracture conductivity was determined using proppant packs sandwiched between Ohio sandstone cores with a proppant particulate loading of 1.7 lb/ft², unless otherwise indicated, of fracture surface. The system was allowed to relax under 1000 pounds per square inch (psi) of confining stress at 150° F. and the proppant pack permeability was measured by cross flowing a 2% aqueous KCl solution under a small pressure gradient. The permeability was multiplied by the pack height and reported as the fracture conductivity, as measured in mD-ft.

During the testing, the applied stress (closure stress) was incremented in 2000 psi intervals from 1000 psi to 8000 psi, and the system was allowed to relax for 50 hours before determining the conductivity at the stress level of interest. FIG. 12A illustrates a chart representing the results of the fracture conductivities. As shown, the shot coke (DC2) that was thermally post-treated and was treated to remove fines exhibited greater conductivity compared to the baseline samples (having neither heat treatment nor fines removal). Moreover, even without fines removal, the thermally post-treated DC2 sample showed greater conductivity compared to the baseline samples.

As an additional comparison, the fracture conductivity of the shot coke sample treated at 700° C. and having fines removed (DC2—700° C.+fines removal) was compared to an untreated shot coke sample (DC2—no heat), three separate fluid coke type samples (FC1, FC2, and FC3), and a flexicoke sample (FX2). Fracture conductivity testing was carried out as described above at a loading of proppant particulate loading of 2 lb/ft² of fracture surface. The results are shown in FIG. 12B.

As shown in FIG. 12B, the thermally post-treated DC2 sample exhibited comparable performance to fluid coke and flexicoke, which are known to possess the mechanical properties necessary for performance as proppant.

Accordingly, the thermally post-treated delayed coke proppant particulates of the present disclosure are suitable for use in hydraulic fracturing operations.

As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is:

1. Proppant particulates, comprising:
first proppant particulates comprising delayed coke that has been thermally post-treated to a temperature in a range of about 400° C. to about 1000° C.

2. The proppant particulates of claim 1, wherein the first proppant particulates consists essentially of delayed coke that has been thermally post-treated to a temperature in a range of about 400° C. to about 1000° C.

3. The proppant particulates of claim 1, wherein the first proppant particulates have a D50 in the range from about 88 microns to about 250 microns.

4. The proppant particulates of claim 1, wherein at least 50 vol % of the first proppant particulates have particle sizes in a range from about 88 microns to about 250 microns.

5. The proppant particulates of claim 1, wherein at least 80 vol % of the first proppant particulates have particle sizes in a range from about 88 microns to about 250 microns.

6. The proppant particulates of claim 1, wherein the first proppant particulates were thermally post-treated for a predetermined duration that is in a range of about 15 minutes to about 24 hours.

7. The proppant particulates of claim 1, wherein the first proppant particulates were thermally post-treated for a predetermined duration that is in a range of about 15 minutes to about 8 hours.

8. The proppant particulates of claim 1, wherein the first proppant particulates were thermally post-treated for a predetermined duration that is in a range of about 15 minutes to about 4 hours.

9. The proppant particulates of claim 1, wherein the first proppant particulates have an apparent density in a range of about 1.2 g/cm³ to about 2.1 g/cm³.

10. The proppant particulates of claim 1, wherein the first proppant particulates have an apparent density in a range of about 1.4 g/cm³ to about 1.6 g/cm³.

11. The proppant particulates of claim 1, wherein the first proppant particulates have a bulk density of less than about 0.8 g/cm³.

12. The proppant particulates of claim 1, wherein the first proppant particulates have a bulk density of less than about 0.7 g/cm³.

13. The proppant particulates of claim 1, wherein the first proppant particulates have a reduced elastic modulus in a range of about 5 gigapascals to about 50 gigapascals.

14. The proppant particulates of claim 9, wherein the first proppant particulates have a hardness value in a range of about 1 gigapascal to about 4 gigapascals.

15. The proppant particulates of claim 1, wherein the first proppant particulates have a weight ratio of carbon to hydrogen of about 50:1 to about 120:1.

16. The proppant particulates of claim 1, wherein the first proppant particulates have a percent of degradables as determined by thermogravimetric analysis in a range of up to about 3%.

17. Proppant particulates, comprising:
first proppant particulates having a D50 in a range from about 88 microns to about 250 microns and comprising delayed coke that has been thermally post-treated.

18. The proppant particulates of claim 17, wherein at least 50 vol % of the first proppant particulates have particle sizes in a range from about 88 microns to about 250 microns.

19. The proppant particulates of claim 17, wherein at least 80 vol % of the first proppant particulates have particle sizes in a range from about 88 microns to about 250 microns.

20. The proppant particulates of claim 17, wherein the delayed coke has been thermally post-treated for a duration of about 15 minutes to about 24 hours.

21. The proppant particulates of claim 17, wherein the first proppant particulates have an apparent density in a range of about 1.2 g/cm³ to about 2.1 g/cm³.

22. The proppant particulates of claim 17, wherein the first proppant particulates have an apparent density in a range of about 1.4 g/cm³ to about 1.6 g/cm³.

23. The proppant particulates of claim 17, wherein at least one of the following is met:
the first proppant particulates have a bulk density of less than about 0.8 g/cm³,
the delayed coke has a sulfur content in a range of about 1 weight percent (wt. %) to about 8 wt. %,
the delayed coke has a volatile matter content in a range of about 8 wt. % to about 15 wt. %, and
the delayed coke has a Hargrove grindability index in a range of about 30 to about 130.

24. The proppant particulates of claim 17, wherein the first proppant particulates comprise delayed coke that has been thermally post-treated to a temperature in a range of about 400° C. to about 1000° C.

25. Proppant particulates, comprising:
first proppant particulates comprising delayed coke and having a bulk density of less than about 0.8 g/cm³.

26. The proppant particulates of claim 25, wherein the first proppant particulates have a bulk density of less than about 0.7 g/cm³.

27. The proppant particulates of claim 25, wherein the delayed coke has been thermally post-treated to a temperature in a range of about 400° C. to about 1000° C.

28. The proppant particulates of claim 25, having a D50 in a range from about 88 microns to about 250 microns.

29. The proppant particulates of claim 25, wherein at least 50 vol % of the first proppant particulates have particle sizes in a range from about 88 microns to about 250 microns.

30. The proppant particulates of claim 25, wherein at least 80 vol % of the first proppant particulates have particle sizes in a range from about 88 microns to about 250 microns.

31. The proppant particulates of claim 25, wherein the first proppant particulates were thermally post-treated for a predetermined duration that is in a range of about 15 minutes to about 24 hours.

32. The proppant particulates of claim 25, wherein the delayed coke has a sulfur content in a range of about 1 weight percent (wt. %) to about 8 wt. %.

33. The proppant particulates of claim 25, wherein the delayed coke has a volatile matter content in a range of about 8 wt. % to about 15 wt. %.

34. The proppant particulates of claim 25, wherein the delayed coke has a Hargrove grindability index in a range of about 30 to about 130.

35. A method for producing proppant particulates, the method comprising:
(a) providing a precursor material comprising delayed coke;
(b) heating the precursor material at a temperature in a range from about 400° C. to about 1200° C. for a predetermined duration to obtain heat treated precursor material; and
(c) obtaining the proppant particles from the heat treated precursor material.

36. The method of claim 35, wherein step (a) comprises:
(a1) providing a delayed coke material;
(a2) grinding and/or sieving the delayed coke material to obtain the precursor material.

37. The method of claim 35, wherein step (c) comprises:
(c1) grinding and/or sieving the heat treated precursor material to obtain the proppant particles.

38. The method of claim 35, wherein in step (a), the precursor material is green delayed coke.

39. The method of claim 37, wherein step (c1) comprises grinding and/or sieving the heat treated precursor material to have a D50 in a range from 88 microns to 250 microns.

40. The method of claim 35, wherein at least 50 vol % of the proppant particles have particle sizes in a range from about 88 to about 250 microns.

41. The method of claim 35, wherein at least 80 vol % of the proppant particles have particle sizes in a range from about 88 to about 250 microns.

42. The method of claim 35, wherein step (b) is carried out at a temperature from about 400° C. to about 1050° C. for the predetermined duration of 15 minutes to 15 hours.

43. The method of claim 35, wherein step (b) is carried out at a temperature from about 400° C. to about 800° C.

44. The method of claim 35, wherein step (b) is carried out at a temperature from about 600° C. to about 800° C.

45. The method of claim 35, wherein step (b) is carried out for the predetermined duration of about 15 minutes to about 8 hours.

46. The method of claim 35, wherein step (b) is carried out for the predetermined duration of about 15 minutes to about 4 hours.
